(19) United States
(12) Patent Application Publication
(10) Pub. No.: US 2007/0261606 A1
(43) Pub. Date: Nov. 15, 2007

(54) Composition for treatment of roadway

(76) Inventor: Bryan K. Sutton, Flint, MI (US)

Correspondence Address: The Weintraub Group, P.L.C., Suite 240, 32000 Northwestern Highway, Farmington Hills, MI, 48334, US

(21) Appl. No.: 11/801,226

(22) Filed: May 9, 2007

Related U.S. Application Data
(60) Provisional application No. 60/800,350, filed on May 15, 2006.

(51) Int. Cl. C08K 3/30; C08K 3/08; C04B 14/48; C04B 28/26

(52) U.S. Cl. 106/640; 524/440; 524/418; 106/815; 106/281.1

(57) ABSTRACT

A powder mixture for improving heat retention in cementitious or similar roadway compositions or a topcoat therefor. This powder mixture is a zinc and sulphur powder mixture. The mixture is added either directly into the roadway composition or is applied as a component of a water-based latex topcoat. The two powders improve the heat retention capability of the roadway composition.

### CROSS-REFERENCE TO RELATED APPLICATIONS

This application is a completion application of co-pending U.S. Provisional Application Ser. No. 60/800,350 filed May 15, 2006 for “Cement Composition” the entire disclosure of which is hereby incorporated by reference.

### BACKGROUND OF THE INVENTION

1. Field of the Invention

The present invention pertains to cementitious products. More particularly, the present invention pertains to cementitious products having heat generating components incorporated therewith. Even more particularly, the present invention pertains to a cementitious product having heat absorbing materials incorporated therewith or incorporated into a topcoat overlying the cementitious product.

2. Description of the Prior Art

As is known to those skilled in the art to which the present invention pertains the ability to melt snow and ice from cement and other road materials is an important process in those regions where there are below-freezing temperatures. Typically, the Northeast, Midwest and Northwest portions of the United States as well as parts of Northern Europe, Asia and Australia during their winters, suffer from these conditions. Usually, snow removal invokes the use of plows, as well as salt, to remove snow and melt ice. However, salt, in and of itself, tends to pit and/or otherwise erode the surface be it tarmac, asphalt, cement and the like. Similarly, plows have a tendency to cut or otherwise disrupt the surface due to the cutting of the surface with the blade of the plow.

The present invention, as hereinafter described, provides a material which absorbs heat and is used to facilitate the melting of the precipitate, be it snow or ice, on the surface of the road.

### SUMMARY OF THE INVENTION

It has been found that by incorporating a mixture of powdered zinc and sulphur either directly into a roadway material and, preferably, cement or concrete or as a topcoat applied thereover, improved melting of ice and/or improved heat absorption of a roadway is accomplished.

In using the two powders, generally, the two powders are present in a respective weight ratio of sulphur to zinc of about 3:1 to about 1:3 and preferably from about 1:1 to about 2:1 whether incorporated into the cement or concrete or other roadway composition or the topcoat.

The topcoat, where used, is preferably, an aqueous latex having the powders admixed therewith.

For a more complete understanding of the present invention reference is made to the following detailed description, and illustrative example.

### DETAILED DESCRIPTION OF THE PREFERRED EMBODIMENT

As noted hereinabove, the present invention contemplates the inclusion of a mixture of powdered sulphur and zinc to improve the heat absorption thereof.

In a first embodiment hereof an improved cement or concrete or other roadway material is provided by incorporating therewith the powder mixture and in a second embodiment hereof, the powder mixture is incorporated into a topcoat for the roadway and is applied thereover.

Turning to the first embodiment hereof, it is contemplated that the powders be incorporated into a cementitious composition. In using the powders to prepare such a cementitious composition, the sulphur will be present in an amount ranging from about 0.5 to about 2.0 parts, by weight thereof, per hundred parts by weight of the total composition. The zinc powder will be present in an amount ranging from about 0.05 to about 2.0 parts, by weight, per hundred parts, by weight, of the total cement composition.

In forming a cement or concrete composition in accordance herewith, generally, the composition will contain about 10 to 35 parts, by weight, of Portland cement, per hundred parts, by weight, of the total composition.

The cement composition will also include from about 70 to about 85 parts of limestone (CaCO₃) or gravel, such as 60-40 gravel, and the like as well as mixtures thereof, also from about two parts to about 10 parts of water, by weight, per hundred parts, by weight, of the total composition.

Although not wishing to be bound by any theory it appears that the minor amount of sulphur warms up the surface of the cement as tires traverse the surface and the zinc powder acts as a heat conductor.

In accordance with the second aspect or embodiment hereof, the powder mixture is incorporated into an aqueous latex topcoat. Such topcoats are well-known and commercially available and, generally, comprise water and a dispersion of polymeric material. When the water evaporates the polymer particles coalesce to form a solid film. With the powders in the latex, they become suspended in the aqueous dispersion and remain as part of the film upon evaporation of the water.

When the powder mixture is used in such a topcoat, the powders will be present, preferably, in about a 3:1 to 1:3 weight ratio of sulphur to zinc in the latex composition. Ordinarily, each of the sulphur and zinc powders will be present in an amount ranging from about 10% to about 20%, by weight, based upon the total weight of the composition.

When the powder mixture is used in the topcoat, the two powders are mixed together or, are added separately, into the aqueous latex at room temperature and with sufficient stirring or agitation to suspend the powders therein. To avoid precipitation of the powders, preferably, the powders are incorporated into the latex at the time of deployment or just prior thereto. The powder-containing latex is then applied by any suitable means such as by spraying, brushing, or the like to form a topcoat over the road surface. Optimally, this is done at ambient conditions.

As noted, the powders do not dissipate on the surface, but rather remain dispersed in the polymer coalescence after evaporation of the water.

The present invention, further, contemplates the incorporation of the powders in both the topcoat and the cement composition.

In practicing the present invention, the zinc powder will have a particle size of about 10 microns and the sulfur will have a mesh size of about 100 mesh.

From the above, it is seen that there has been described a cement composition or topcoat which promotes heat retention therewithin.

Following is an illustrative, non-limiting example of the present invention. In the example all parts are by weight absent indications to the contrary.

### EXAMPLE

This example illustrates the use of the present invention as a cement composition.

A series of cement slabs were prepared during a Fall month by entraining in dry air 388 parts of 60-40 gravel, 70 parts of Portland Cement, 11.1 parts of sulphur, 4.0 parts of zinc, and 33 parts of water and thoroughly mixing the ingredients together to provide a uniform composition.

After first preparing the mixture, two 3×3×4 inch slabs were prepared from this mixture by pouring the so-produced cement into a suitable mold.

Two additional slabs were prepared using the same composition, except that the zinc and sulphur powders were eliminated from the mixture thereto.

Each of the four slabs was allowed to set for seven days in the outdoors during the Fall month where there was an average temperature of about 45° F. After seven days in the outdoors, the surface heat of each slab was measured using a conventional temperature gun. The surface of the slabs having the powder mixture incorporated therewith evidenced a 20° F. temperature differential between the slabs containing the powder mixture and the slabs without.

In addition, after observing the slabs in the ambient, each of the four slabs were exposed to heat using a 250 watt heat lamp which was directly focused onto each slab for a period of 5 minutes while the temperature in the outdoors was about 40° F. The temperature of the surface of each slab was then measured using a Temperature gun. The surface of the slabs having the zinc and sulphur admixture within the cement showed a temperature of about 75° F., whereas the slabs without the zinc and sulphur mixture only measured about 49° F.

From the above, it is seen that with the zinc and sulphur admixture heat retention is greatly increased.

Having thus described the invention what is claimed is:

1. In a composition for improving heat retention by a roadway, the improvement which comprises:
a zinc and sulphur powders admixture, the admixture being incorporated into the roadway composition or into a topcoat for the roadway.

2. The improvement of claim 1 wherein:
the zinc and sulphur powders are present in a respective rate ratio of about 1:3 to about 3:1.

3. The improvement of claim 1 wherein:
the admixture is in the roadway composition, the roadway being a cement composition.

4. The improvement of claim 3 wherein:
(a) the zinc is present in an amount ranging from about 0.05 parts to about 2.0 parts per weight per hundred parts by weight of the total cement composition and (b) the sulphur is present in an amount ranging in an amount from 0.5 parts to about 2.0 parts by weight per hundred parts by weight of the total composition

5. The improvement of claim 1 wherein:
the admixture is present in the roadway topcoat.

6. The improvement of claim 5 wherein the topcoat is a water-based latex topcoat.

7. The improvement of claim 5 wherein the zinc and sulphur powders are each present in an amount ranging from about 10% to about 20% by weight, based upon the total weight of the latex and powders.

8. A topcoat for cement which comprises:
a water-based latex having admixed therewith zinc and sulphur powders, the zinc and sulphur powders being present in a respective rate ratio of about 1:3 to about 3:1.

9. The improvement of claim 1 wherein the roadway composition is selected from the group consisting of cement, concrete, asphalt, and tarmac.

10. The improvement of claim 1 wherein the zinc powder has a mesh size of 10 microns and the sulphur has a mesh size of about 100 mesh.
